(19) United States
(12) Patent Application Publication
(10) Pub. No.: US 2007/0068208 A1
(43) Pub. Date: Mar. 29, 2007

(54) Electronic tag housing for support on a bottle bottom

(75) Inventors: Michael Norman, East Brunswick, NJ (US); Chester Kolton, Westfield, NJ (US); Robert Whittemore, Montgomery, NY (US)

Correspondence Address: HOFFMANN & BARON, LLP, 6900 JERICHO TURNPIKE, SYOSSET, NY, 11791, US

(73) Assignee: B&G Plastics, Inc.

(21) Appl. No.: 11/526,854

(22) Filed: Sep. 25, 2006

Related U.S. Application Data
(60) Provisional application No. 60/720,815, filed on Sep. 27, 2005.

(51) Int. Cl. E05B 29/00

(52) U.S. Cl. 70/357

(57) ABSTRACT

An electronic tag housing supports an electronic tag such as an electronic article surveillance (EAS) tag, a radio frequency identification (RFID) tag, or the like to the recessed bottom of a bottle. The tag housing is designed to have a configuration which is received in the recess of the bottle bottom. The housing, which supports the electronic tag, is accommodated within the bottle bottom without interfering with the ability of the bottle to stand upright. Moreover, the tag housing remains unobtrusive during use.

### CROSS-REFERENCE TO RELATED APPLICATION:

This application claims priority to U.S. Provisional Patent Application No. 60/720,815, filed on Sep. 27, 2005, which is incorporated herein by reference.

### FIELD OF THE INVENTION

The present invention relates to an electronic tag housing used to support an electronic tag. More particularly, the present invention relates to a housing which supports an electronic tag and which may be secured to a container such as a bottle.

### BACKGROUND OF THE INVENTION

It is widely known to use electronic tags for various purposes. Electronic article surveillance (EAS) tags as well as radio frequency identification (RFID) tags are used for purposes such as tracking sales and shipments of products to which they are attached. They also may be used to provide theft deterrence to articles to which they are attached.

It is also known to apply such electronic tags to various product containers such as beverage bottles. Commonly assigned U.S. Pat. Nos. 6,696,955 and 6,324,838 show housings for EAS markers which are used in combination with containers having an inlet/outlet port. The tag housing is configured to be passable through the port for residence within the container.

Other housings which accommodate electronic tags may be supported between the neck of a bottle and the removable bottle cap. Such devices are shown in U.S. Pat. Nos. 6,604,643 and 4,813,564.

Other devices support the tag housing directly in the cap itself such as shown in U.S. Pat. No. 6,137,413.

While each of these devices serves adequately for its intended purposes, it is desirable to provide an electronic tag housing which may be easily applied to the exterior surface of the bottle. Placing such tags directly on the exterior surface of the bottle has significant drawbacks. First, placement on the exterior surface of the bottle may be cumbersome and may interfere with use of the bottle. Second, such placement on an exterior surface of the bottle makes it readily apparent and, therefore, susceptible to unauthorized removal.

It is desirable to provide an electronic tag housing which may be easily applied to the exterior of a bottle, yet remain unobtrusive during use.

### SUMMARY OF THE INVENTION

The present invention provides an electronic tag housing for support within a recessed bottom of a bottle such as a beverage bottle. The tag housing supports an electronic tag and has a configuration such that it is received and retained in the recess of the bottle bottom. The housing is accommodated within the bottle bottom without interfering with the ability of the bottle to stand upright.

Preferably, the housing may be adhesively secured within the recess of the bottle bottom. The housing may be configured to correspond to different configurations of bottle bottom recesses.

### BRIEF DESCRIPTION OF THE DRAWINGS

FIG. 1 shows schematically a bottle including a recessed bottom which accommodates the tag housing of the present invention.

FIG. 2 is a bottom perspective showing of one embodiment of the tag housing of the present invention.

FIG. 3 is a sectional showing of the tag housing of FIG. 2.

FIG. 4 is an exploded perspective showing of the tag housing of FIG. 2 including an electronic tag for support therein.

FIGS. 5, 6 and 7 show, respectively, the bottom, front and side elevational showings of a further embodiment of the tag housing of the present invention.

FIG. 8 is a top perspective showing of the tag housing embodiment of FIG. 5.

FIG. 9 is a top perspective showing of a further embodiment of the tag housing of the present invention.

FIG. 10 is a cross-sectional showing of the tag housing of FIG. 9.

FIG. 11 is a bottom perspective showing of the tag housing of FIG. 9.

FIG. 12 is a perspective showing of the cover employed with the tag housing shown in FIG. 11.

### DETAILED DESCRIPTION OF THE PREFERRED EMBODIMENT:

The present invention provides a housing for supporting an electronic tag such an electronic article surveillance (EAS) tag or a radio frequency identification (RFID) tag. The tag housing of the present invention is designed for use with various types of bottles having recessed bottoms. Such bottles include beverage bottles, particularly liquor bottles.

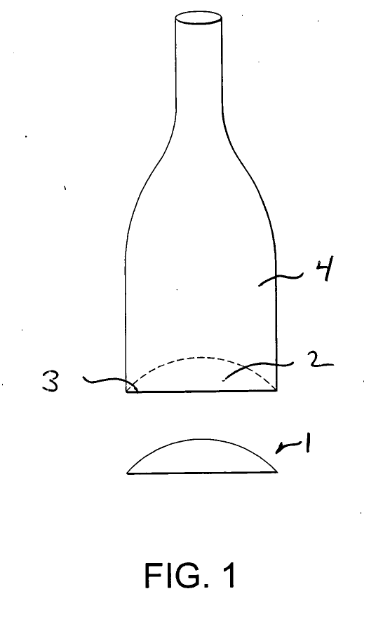

As shown in FIG. 1, the housing 1 is designed to conform to a recess 2 in the bottom 3 of a bottle 4. The housing is designed so as to be unobtrusive and so that its position will not interfere the ability of the bottle to stand upright.

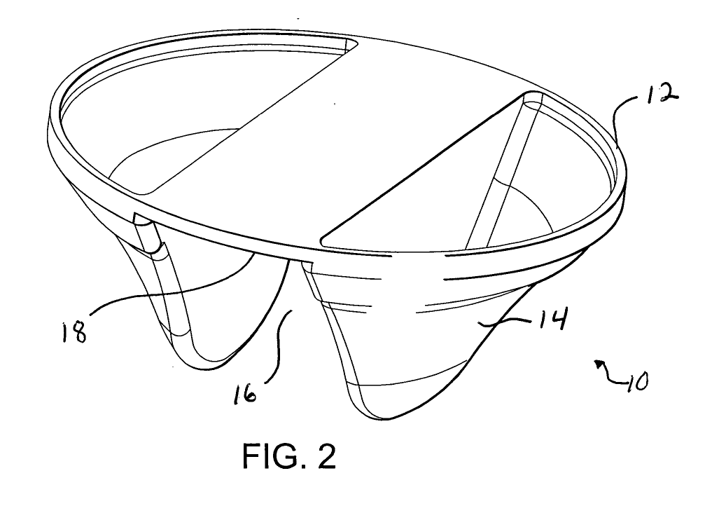

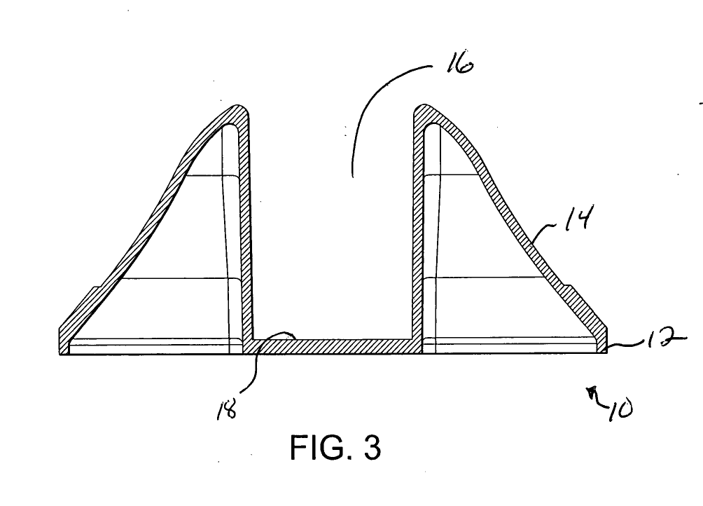

Referring to FIGS. 2-4, a first example of one such tag housing is shown. Housing 10 is a molded plastic component having a circular base 12 and a tapered upstanding wall 14. The wall is generally conical so as to mate with a bottle having a conically recessed bottom. The wall 14 is divided by a central channel 16 which provides a flat bottom surface 18 for securement of tag 20 thereto. The housing 10 is generally hollow so as to reduce its weight and material for ease and economy of manufacture. The tag 20 may be secured to the bottom surface by adhesive or the like. A cover 21 may be placed thereover to enclose the tag 20.

The generally circular bottom of housing 10 is approximately the size of the recess of the bottle onto which it is secured. Furthermore, the upstanding wall 14 also corresponds to the depth and configuration of the recess. It is contemplated that the housing may be secured within the recess of the body by applying adhesive to wall 14.

The housing 10 is supported within the recess of the bottle such that the circular base 12 is recessed from the bottle bottom such that it does not protrude out from the recess and thereby is both unobtrusive and out of interference with the ability of the bottle to stand upright. In this manner, the beverage bottle may be sold and used without calling attention to the housing supporting the electronic tag.

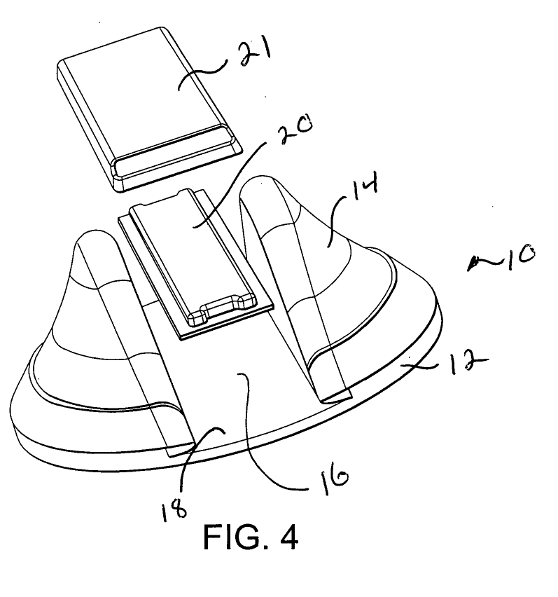

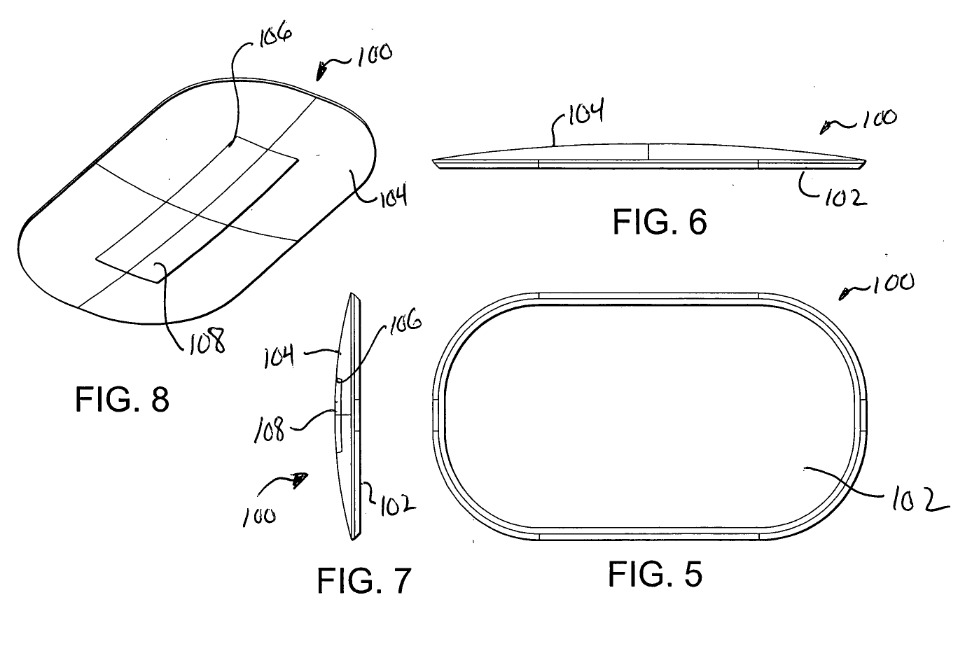

A further embodiment of the tag housing is show in FIGS. 5-8. Housing 100 is generally elliptical in shape having a flat bottom 102 and an opposed curved upper surface 104. The upper surface 104 includes a rectangular recess 106 for supporting an electronic tag 108. Housing 100 is designed for support in bottle bottom having a relatively shallow recess. As with the embodiment described above, housing 100 designed so that the entire housing is positioned within the recess in a manner that it does not extend outwardly from the bottle, again, making the housing unobtrusive and in noninterference with the ability of the bottle to stand upright.

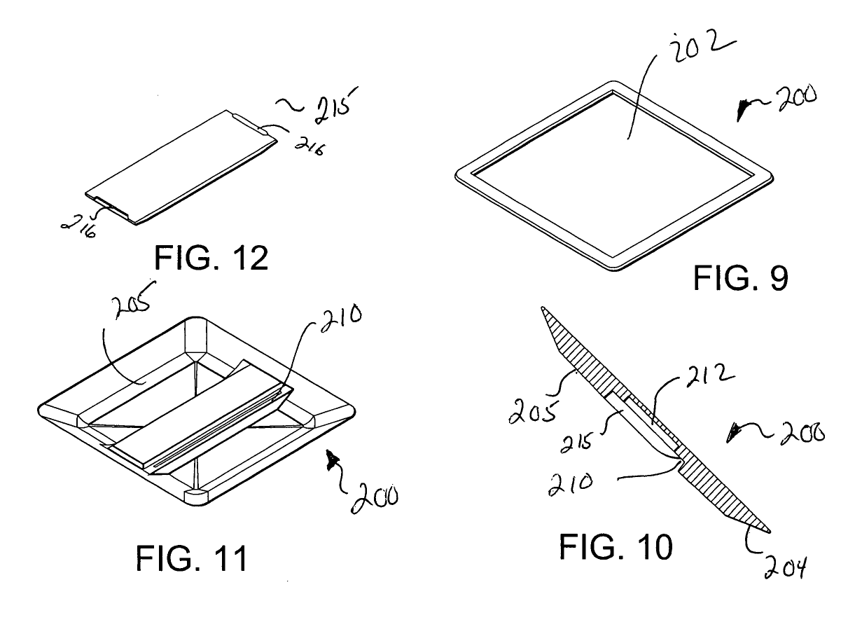

A still further embodiment of a housing is shown in FIGS. 9-12. Housing 200 has a square base 202, upwardly extending tapered perimetrical side walls 204 and a flat upper surface 205. Housing 200 is used in combination with a bottle which has a relatively narrow bottom recess.

Housing 200 includes a central slot 210 provided in the flat upper surface 205. The slot 210 supports an electronic tag 212 therein. A cover 215 may be secured over slot 210 to enclose the tag 212. The cover 215 maybe snap fitted into slot 210 using tabs 216.

It may be appreciated that the present invention allows an electronic tag to be supported to a beverage bottle in a manner which does not interfere with the use of the bottle. Moreover, the tag remains relatively hidden from ordinary view, thereby reducing the likelihood of an unauthorized removal therefrom.

Various changes to the foregoing described and shown structures would now be evident to those skilled in the art. Accordingly, the particularly disclosed scope of the invention is set forth in the following claims.

What is claimed is:

1. A device for supporting an electronic tag in a recessed bottle bottom comprising:
a housing having a configuration which is received in a recess in a bottle bottom, said housing being accommodated within said bottle bottom without interfering with the ability of said bottle to stand; and
an electronic tag supported by said housing.

2. A device of claim 1 wherein said housing is adhesively secured within said recess of said bottle bottom.

3. A device of claim 1 wherein said housing is configured to correspond to said recess.

4. A device of claim 1 wherein said housing includes a slot for accommodation of said electronic tag.

5. A device of claim 4 further including a cover attachable to said housing for enclosing said tag in said slot.

6. A device of claim 2 wherein said housing further includes a housing surface for said adhesive secured to said bottle bottom.

7. In combination:
a beverage bottle having a recessed bottom and a rim thereabout on which said bottle stands;
a tag housing having a configuration corresponding to said recess and affixed therein wherein said housing does not extend beyond said rim; and
an electronic tag supported within said housing.

8. The combination of claim 4 wherein said tag is adhesively attached to said recessed bottom.

9. The combination of claim 4 wherein said tag is selected from the group consisting of an article surveillance tag and a radio frequency identification tag.

10. The combination of claim 1 further including a cover for covering said tag.
